(19) United States
(12) Patent Application Publication
(10) Pub. No.: US 2009/0205929 A1
(43) Pub. Date: Aug. 20, 2009

(54) ARTICLE SELECTION AND LOADING SYSTEM

(76) Inventor: Pascal DeGuglielmo, Montgveux (FR)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 12/031,594

(22) Filed: Feb. 14, 2008

(51) Int. Cl. B65G 35/00

(52) U.S. Cl. 198/347.1

(57) ABSTRACT

A system for loading articles into containers includes a first conveying mechanism for conveying containers to form a first stream of containers providing containers of a first type, a second conveying mechanism for conveying containers to form a second stream of containers providing containers of a second type, and a third conveying mechanism for conveying articles to form a stream of articles. The system further includes one or more articulated tools for selecting articles from the stream of articles and depositing those selected articles to load containers of the first stream of containers and a transfer mechanism for transferring loaded containers from the first stream of containers into containers from the second stream of containers.

### FIELD OF INVENTION

The present invention relates particularly, though not exclusively, to systems for loading containers with articles. More specifically, though not exclusively, the present invention relates to such a system wherein an articulated tool is employed to achieve the loading of the products into corresponding cartons. Yet more specifically, though still not exclusively, the present invention relates to a system wherein the loaded containers from one stream may be grouped and loaded into a container of another stream.

### BACKGROUND OF THE INVENTION

It is common in the packaging industry to require that articles be loaded, from an initial stream, into corresponding containers distributed separately upon respective conveyors. The requirement for high throughput speeds necessitates that a system for achieving this be capable of quickly selecting articles disposed upon one conveyor and transferring those selected articles into a respective carton at a high rate and with a high degree of accuracy. Additionally, there is often a requirement that Individual article cartons be grouped together and loaded into a further container, for example, for transportation or point of sale purposes.

It is known in the art that systems employing controllable articulated tools are suitable for selecting articles from one conveyor and displacing them reliably and accurately into respective containers disposed upon another conveyor. European Patent 0,856,465 (to Schubert) describes a system wherein such articulated tools are employed in a sequential line, and disposed overhead a stream of articles, thereby to select articles and load them into containers disposed upon a second conveyor. However, the system disclosed by Schubert comprises an initial in-feed of products that is unregulated and hence requires detection element to locate, and determine the orientation of, each article in turn prior to the selection.

A problem associated with the prior art is that systems such as that disclosed in Schubert require complex and expensive identification and visualisation apparatus to detect random arrays of articles on a conveyer. This can limit the throughput of the system. Further, the systems of the prior art do not contemplate any arrangement wherein articles may be placed in containers from either of two separate streams, which streams comprise differing container types, nor that the loaded containers of a first stream may be grouped and transferred into containers of a second stream for, say, transportation for point of sale purposes.

The present invention seeks to overcome or at least mitigate these and other problems of the prior art.

### SUMMARY OF THE INVENTION

A first aspect of the present invention provides a system for loading articles into containers, which system comprises a first conveyor for conveying containers to form a first stream of containers comprising containers of a first type, a second conveyor for conveying containers to form a second stream of containers comprising containers of a second type, a third conveyor for conveying articles to form a stream of articles, one or more articulated tools for selecting articles from the stream of articles and depositing those selected articles to load containers of the first stream of containers, and a transfer element for transferring loaded containers from the first stream of containers into containers from the second stream of containers.

In one embodiment, the system further comprises apparatus for closing containers from the first stream of containers once they have been loaded

In one embodiment, the system further comprises a position at which loaded containers from the first stream of containers are queued, awaiting transfer into containers from the second stream of containers by the transfer element.

In one embodiment, the transfer element comprises a collating element for collating loaded containers from the first stream of containers, such that the transfer element can transfer those collated containers, into containers from the second stream of containers, as a group.

In one embodiment, the transfer element comprises one or more conveyors.

In one embodiment, the transfer element comprises fourth and fifth conveyors, which fourth and fifth conveyors are arranged such that at least one container reaching a downstream terminal end of the fourth conveyor is positioned upon the fifth conveyor.

In one embodiment, the fourth and fifth conveyors are arranged such that a container passing from the fourth conveyor to the fifth conveyor is rotated from a first orientation into a second orientation.

A second aspect of the present invention provides a system for loading articles into containers, which system comprises, conveyor(s) for conveying articles and set-up containers in respective, substantially parallel, streams, a transfer element for transferring articles in the stream of articles into containers in the steam of containers, which transfer element rotates those articles from an initial first orientation into a subsequent second orientation.

In one embodiment, the articles are conveyed in a direction opposing that in which a stream of containers is conveyed.

In one embodiment, each of the containers in each stream of containers are regularly spaced from one another by a predetermined distance.

In one embodiment, the articles in the stream of articles are placed upon the first conveyor at predetermined positions.

In one embodiment, the articulated tools are controlled so as to, collectively, visit each of said predetermined locations upon said first conveyor.

A third aspect of the present invention provides a method for loading articles into containers, which method comprises conveying articles in a stream, conveying containers in a first stream, conveying containers in a second stream, selecting articles from the stream of articles using one or more articulated tools, depositing the selected articles into a container from the first stream, and transferring loaded containers from the first stream into containers from the second stream.

In one embodiment, the method further comprises the step of closing the containers from the first stream of containers once they have been loaded with articles.

In one embodiment, the method further comprises queuing the loaded containers from the first stream of containers and subsequently transferring the containers using a transfer element.

In one embodiment, the method further comprises collating loaded containers received from said first stream of containers at said transfer element to allow transfer of said containers into the containers from the second stream of containers as a group.

In one embodiment, the method further comprises rotating the containers from a first orientation to a second orientation as they are transferred.

A fourth aspect of the present invention provides a method for loading articles into containers, which method comprises forming a set-up container from a respective blank, conveying articles and set-up containers in respective, substantially parallel streams, transferring articles in one of those steams into containers in the other of those steams and in so doing rotating those articles from an initial first orientation into a subsequent second orientation.

In one embodiment, the method further comprises conveying the articles in a direction opposing that in which one of the streams of containers is conveyed.

In one embodiment, the method further comprises spacing the articles in the stream of articles in a predetermined array.

In one embodiment, the method further comprises spacing the articles in the stream of articles at known or predetermined locations.

### BRIEF DESCRIPTION OF THE FIGURES

Various exemplary embodiments of the present invention will now be described with reference to the accompanying Figures, in which:

FIG. 1 illustrates a system according to a first embodiment of the present invention; and

FIG. 2 illustrates a system according to a second embodiment of the present invention.

### DETAILED DESCRIPTION OF THE INVENTION

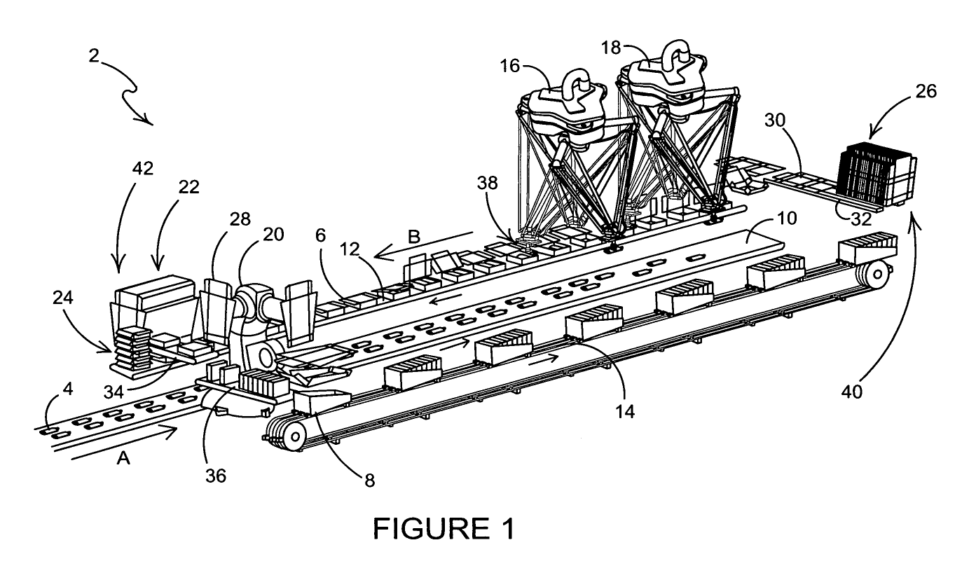

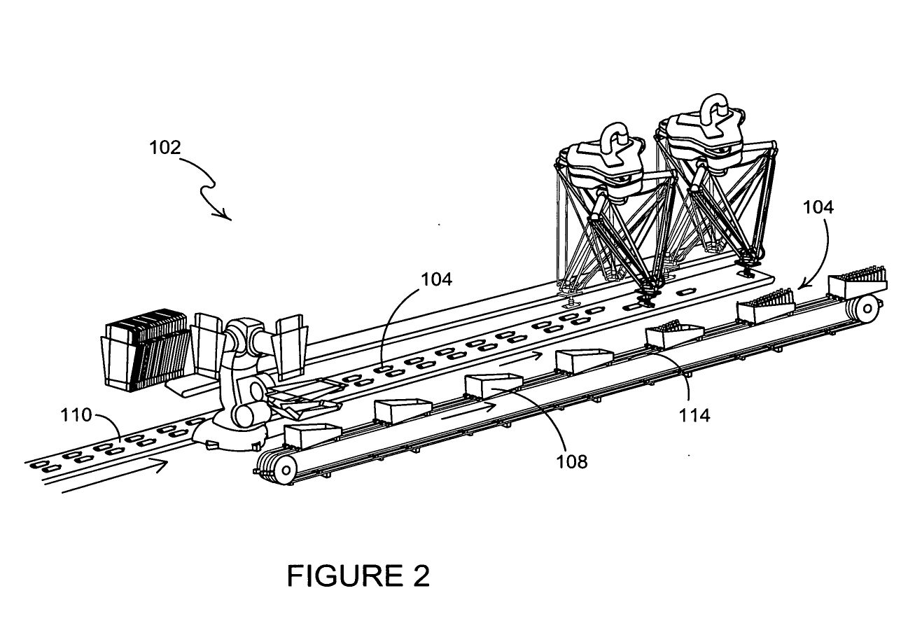

FIGS. 1 and 2 illustrate two exemplary embodiments of the present invention which each provide a system 2, 102 that loads products/articles 4, 104, into a first type of container 6 or a second type of container 108. In the first embodiment, the first type of containers 6 are cartons that, once fully loaded, are then themselves grouped and loaded within display containers 8 prior to being delivered to an out-feed end of the system.

Describing now the first embodiment of the system 2, as shown in FIG. 1, the system 2 comprises primarily first 10, second 12 and third 14 conveyors, articles 4, cartons 6, and display containers 8. Articles 4 are disposed in a regulated stream upon a first conveyor 10 whilst cartons 6 are disposed upon a second conveyor 12, and display containers 8 are disposed upon a third conveyor 14. Disposed substantially overhead of the first conveyor 10 are articulated tools 16, 18 arranged in sequence along a portion of the length of the first conveyor 10. Second and third conveyors 12, 14 are orientated parallel with first conveyor 10 and are off-set therefrom on either side. The first 10 and third 14 conveyors convey the articles 4 and display containers 8 in a first direction, as indicated by arrow A, whilst the second conveyor 12 conveys the cartons 6 in an opposing direction, as indicated by arrow B.

In operation, the articles 4 are disposed upon a first conveyor 10 at predetermined positions upon the first conveyor 10, which first conveyor conveys those articles 4 in the aforementioned first direction A, as a regulated stream of articles. Meanwhile, the cartons 6 are fed into the system 2 from a carton in-feed end and become disposed upon the second conveyor 12 and thus conveyed, in an opposing direction B to the aforementioned first direction A. As the articles 4 are conveyed upon the first conveyor 10 they move into a working reach of the first articulated tool 16 and, if not selected by the first articulated tool 16, then continue on into a working reach of second articulated tool 18.

The cartons 6 are fed into the system 2 at a container in-feed end 40 in the form of a magazine (hopper) 26 of carton blanks 30 which blanks 30 are transferred sequentially, upon a blank conveyor 32, to an upstream terminal end of second conveyor 12. The blanks 30 are transferred from the terminal end of blank conveyor 32 to an upstream terminal end of the second conveyor 12 by a transfer element known in the art and, in so doing, are at least partially set-up (by static guides or other folding tools) such that, once brought into the working reach of the second articulated tool 18, the cartons 6 are sufficiently set-up to receive the articles 4. In another embodiment, the cartons 6 are not completely set-up at this stage and the setting-up of the cartons 6 continues as the at least partially set-up blanks 30 are conveyed upon the second conveyor 12.

First and second articulated tools 16, 18 select articles 4 from the first conveyor 10 and transfer each selected article 4 into a position above a respective carton 6. Depending upon the throughput rate of the system 2, the first articulated tool 16 may not have sufficient time to select all of the articles 4 within its working reach before those articles 4 pass from the working reach of first articulated tool 16 to that of second articulated tool 18. Thus, the second articulated tool 18 is responsible for selecting any articles 4 that do leave the working reach of first articulated tool 16 and placing them within cartons 6 upstream of the stream of cartons 6 into which the articles 4 are placed by the first articulated tool 16. It is thereby ensured that no articles 4 remain upon the first conveyor 10 after leaving the working reach of second articulated tool 18. Further, the use of a second articulated tool 18 reduces the number of selections required of the first articulated tools 16 and thus ensures that no cartons 6 leave the working reach of the first articulated tools 16 without being completely filled with articles 4.

Once the filled cartons 6 leave the working reach of first articulated tool 16 upon the second conveyor 12, apparatus for completing remaining folding operations to close the carton 6 around the articles 4 are provided. In other embodiments, where the construction of the carton 6 is completed at this stage, the aforementioned apparatus is not provided and as such is an optional feature. The exact nature of the folding operations would be readily understood by one skilled in the art and is not a limiting feature of this invention. Thus, the fully loaded and closed cartons 6 are conveyed to, and queued at, a stacking point 24 wherein a, In one embodiment vertical stack of containers 6 is created and temporarily held in place before each loaded carton 6 is transferred, sequentially, by transfer element 34, 36 to a collation point above an upstream end of the third conveyor 14. The transfer element 34, 36, is disposed over the first conveyor 10 such that the passage of cartons 6 does not interrupt the flow of articles 4 thereupon.

Optionally, the transfer element comprises two distinct stages 34, 36 that are arranged such that the cartons 6 originally disposed horizontally upon a first stage 34, may be brought into an upright orientation on the second stage 36. In the illustrated embodiment, the first transfer stage 34 comprises a first conveyor belt and the second transfer stage 36 comprises a second conveyor belt. The first conveyor belt terminates over an upstream end of the second conveyor belt. The loaded cartons 6 are conveyed upon the first conveyor belt 34 in a horizontal orientation until they are urged off of a terminal end thereof and come to rest upon a moving surface of the second conveyor belt 36. The vertical spacing of the two first 34 and second 36 transfer stages is such that the cartons 6 have sufficient clearance to rotate from a horizontal orientation to an upright orientation as they come to rest upon the second transfer stage 36. Thus cartons 6 reach a terminal end of the second transfer stage 36 in a vertical orientation and are collated into a queued group, awaiting transfer into display containers 8.

The display containers (or tertiary packaging containers) 8 are fed into the system 2 at a display container in-feed end 42 and are initially in the form of blanks 28 held in a magazine (hopper) 22. Blanks 28 are sequentially extracted from the magazine 22 by a robotic arm 20, wherein robotic arm 20 rotates each sequentially extracted blank 28 so as to reorientate it substantially co-planar with a surface of the third conveyor 14. As each blank 28 is being lowered down onto the surface of the third conveyor 14 it undergoes a setting up process such that by the time it is correctly positioned on the surface of third conveyor 14 it is in a substantially set-up condition. One or more of the cartons 6, queued at the terminal end of the second transfer element 36 are then transferred into the display container 8 prior to the display container B being conveyed upon the third conveyor 14 to an out-feed end of the system 2.

A second embodiment of the present invention 102, is illustrated in FIG. 2, and features common to the first and second embodiments have been referenced by like numerals, albeit with prefix of “1” added to distinguish that the features are of the second embodiment. The second embodiment of the system 102 is one in which the articles (primary containers for example cans; bottles or combination such containers) 104 are disposed directly within the display container 108, rather than the cartons 6 shown in FIG. 1. The system 102, according to this second embodiment of the invention 102, will now be described with reference to only the differences between that system 102 and the system of the first embodiment of the present invention 2.

As shown In FIG. 2, the second embodiment of the system 102 does not comprise the apparatus associated with the cartons 8 (secondary packages) of FIG. 1. This being an optional sub-assembly. The second conveyor 12, of FIG. 1, is not used and all conveyance of the articles 104 and display containers 108 is achieved by first 110 and third 114 conveyors, respectively. The orientation of the articles 104 within the display containers 108 differs from that of the first embodiment in that the articles 104 are placed vertically in the display containers 108 so as to maximise the number of articles 104 that may be accommodated therein.

It can be seen that the articulated tools 16/116, 18/118 may be flexibly employed so as to provide a system that accommodates multiple configurations of product loading.

In both embodiments of the system 2/102, the in-feed stream of articles 4/104 are disposed upon the first conveyor 10/110 in a regulated distribution such that the position and orientation of the articles 4/104, upon the surface of the conveyor is predetermined. The articulated tools 16/116, 18/118 need not, therefore, specifically detect the position and orientation, of each individual product before it is selected, but merely confirm that a product is present at any given moment in each of what may be considered ‘quantised’ locations. This greatly simplifies the requirements of the system in that the exact location and exact orientation of any given product need not be ascertained by, for example, machine vision, and thus the technical complexity of the system is reduced. Of course, it will be appreciated that the locations of the articles 4,104 may not provide a regular appearing array, it is only necessary that the articulated tools 16,116; 18, 118 know the predetermined or intended locations of the articles 4, 104.

Nonetheless, it is contemplated within the scope of this invention that the stream of articles 4/104 may, in fact, be unregulated (that is to say, not provided in a regular array), thus necessitating the provision of the detection systems known in the art such as those disclosed in Schubert, which detection systems allow the exact location and exact orientation of any given product to be detected prior to selection of the articles 4/104 by one or either of the articulated tools 16/116, 18/118. When used in such a way, the present invention is advantageous over the system provided by Schubert by virtue of the fact that it allows multiple configurations of article loading, including the loading of articles into intermediate containers which then finally become transferred into subsequent display container.

In both exemplary embodiments of the system 2/102 the articulated tools 16/118, 18/118 In one embodiment take the form of robotic manipulators, however it is contemplated that other apparatus capable of grasping each selected article 4/104 and moving that selected article 4/104 to a point over a given container 8/108 could be used in place of or in addition to a robotic manipulator. It is also contemplated that the articulated tools 16/116, 18/118 optionally also are capable of reorientation of the articles 4/104 through rotation in at least one axis. The articulated tools 16/116, 18/118 release the selected articles 4/104 either above a surface of the containers 6, 108, or when they come into contact with that surface. If the articles 4/104 are suitably robust it may speed up the throughput of the system if the articles 4/104 were dropped, but more accurate and less physically damaging operation would result from releasing the articles 104 only once they come into contact with the container 6/108.

Any directional references in the above description are exemplary in nature and are not limiting to the scope of the invention, it is contemplated that many alterations to the specific embodiments described above may be employed whilst remaining within the scope of the invention as defined by the claims attached hereto, specifically the number and arrangement of the articulated tools may be altered depending, for example, upon the throughput rates required of the system. For example, the number of articles 4 in the regular stream may be greater or less than as shown. Likewise the nature of the cartons 6 and display containers 8 of FIG. 1 may be altered to suit the specific requirements of the final application. It may also be the case that both second and third conveyors are used to convey identical containers such that the products are selected and placed so as to fill those containers on both conveyors concurrently. The process by which the blanks that are fed into the system are set-up for, or at least partially set-up, are well known in the art and the above disclosure is not limited by any particular process thereof. Whilst articles 104 of FIG. 2 are described as being loaded vertically into the display cartons 108 of the second embodiment, it is specifically contemplated that the orientation of those products may be altered as necessary, to suit the requirements of the end user.

1. A system for loading articles into containers, which system comprises a first conveyor for conveying containers to form a first stream of containers comprising containers of a first type, a second conveyor for conveying containers to form a second stream of containers comprising containers of a second type, a third conveyor for conveying articles to form a stream of articles, one or more articulated tools for selecting articles from the stream of articles and depositing those selected articles to load containers of the first stream of containers, and a transfer element for transferring loaded containers from the first stream of containers into containers from the second stream of containers.

2. The system of claim 1 further comprising apparatus for closing containers from the first stream of containers once they have been loaded.

3. The system of claim 1 further comprising a position at which loaded containers from the first stream of containers are queued, awaiting transfer into containers from the second stream of containers by the transfer element.

4. The system of claim 1, wherein said transfer element comprises a collating element for collating loaded containers from the first stream of containers, such that the transfer element can transfer those collated containers, into containers from the second stream of containers, as a group.

5. The system of claim 1, wherein said transfer element comprises one or more conveyors.

6. The system of claim 1, wherein said transfer element comprises fourth and fifth conveyors, which fourth and fifth conveyors are arranged such that at least one container reaching a downstream terminal end of the fourth conveyor is positioned upon the fifth conveyor.

7. The system of claim 6, wherein the fourth and fifth conveyors are arranged such that a container passing from the fourth conveyor to the fifth conveyor is rotated from a first orientation into a second orientation.

8. A system for loading articles into containers, which system comprises, conveyors for conveying articles and set up containers in respective, substantially parallel, streams, a transfer element for transferring articles in the stream of articles into containers in the steam of containers, which transfer element rotates those articles from an initial first orientation into a subsequent second orientation.

9. The system of claim 1 or claim 8, wherein the articles are conveyed in a direction opposing that in which a stream of containers is conveyed.

10. The system of claim 1, wherein each of the containers in each stream of containers are regularly spaced from one another by a predetermined distance.

11. The system of claim 1, wherein the articles in the stream of articles are placed upon the first conveyor at predetermined positions.

12. The system of claim 11 wherein the articulated tools are controlled so as to, collectively, visit each of said predetermined positions upon said first conveyor.

13. A method for loading articles into containers, which method comprises conveying articles in a stream, conveying containers in a first stream, conveying containers in a second stream, selecting articles from the stream of articles using one or more articulated tools, depositing the selected articles into a container from the first stream, and transferring loaded containers from the first stream into containers from the second stream.

14. The method of claim 13 further comprising the step of closing the containers from the first stream of containers once they have been loaded with articles.

15. The method of claims 13 comprising queuing the loaded containers from the first stream of containers and subsequently transferring the containers using said transfer element.

16. The method of claims 15 comprising collating loaded containers received from said first stream of containers at said transfer element to allow transfer of said containers into the containers from the second stream of containers as a group.

17. The method of claim 16, comprising rotating the containers from a first orientation to a second orientation as they are transferred.

18. A method for loading articles into containers, which method comprises forming a set-up container from a respective blank, conveying articles and set-up containers in respective, substantially parallel streams, transferring articles in one of those steams into containers in the other of those steams and in so doing rotating those articles from an initial first orientation into a subsequent second orientation.

19. The method of claim 18, comprising conveying the articles in a direction opposing that in which one of the streams of containers is conveyed.

20. The method of claim 13 comprising spacing the articles in the stream of articles in a predetermined array.

21. The method of claim 18 comprising spacing the articles in the stream of articles at known or predetermined locations.
